(19) United States
(12) Patent Application Publication
(10) Pub. No.: US 2025/0076812 A1
(43) Pub. Date: Mar. 6, 2025

(54) TOOL AND METHOD FOR THE SEPARATION OF BALANCE SPRINGS AFTER WINDING IN AND HEAT TREATMENT

(71) Applicant: Nivarox-FAR S.A., Le Locle (CH)

(72) Inventors: Daniel MALLET, Le Belieu (FR); Lionel MICHELET, Sainte-Croix (CH); Marco VERARDO, Les Bois (CH)

(73) Assignee: Nivarox-FAR S.A., Le Locle (CH)

(21) Appl. No.: 18/810,616

(22) Filed: Aug. 21, 2024

(30) Foreign Application Priority Data
Sep. 6, 2023 (EP) 23195657.4

(51) Int. Cl. G04B 17/06

(52) U.S. Cl. CPC G04B 17/066

(57) ABSTRACT

A tool for separating a plate of balance springs after winding in, including substantially parallel lower and upper rolling surfaces which are movable relative to one another, vertically or longitudinally, in order to deform the plate by ovalisation, and to subject it to a rolling movement between the rolling surfaces, and further relates to a method for separating balance springs from a plate using this tool in order to mechanically crush it in the elastic range and initiate sequences of compressing and rolling the plate.

### TECHNICAL FIELD OF THE INVENTION

The invention relates to a tool for separating a substantially cylindrical or annular balance spring plate after winding in and heat treatment, said tool being arranged to initiate or carry out the separation of said balance springs.

The invention further relates to a method for separating balance springs from a plate after winding in and heat treatment.

The invention relates to the manufacture of horological balance springs, in particular oscillator springs.

### TECHNOLOGICAL BACKGROUND

Oscillator balance springs are formed by winding between 3 and 6 metal blades to form a balance spring plate; this creates an Archimedean spiral with a regular pitch between each coil. The plates are then heat-treated (fixed) so that they retain this spiral shape. This method generates a large contact surface between the small metal plates, and the step of separating the balance springs from each other can be complicated: the balance springs are said to ‘stick’. This problem is particularly prevalent when the balance springs are made of a titanium-based alloy, whereas steel balance springs typically do not present separation problems.

A conventional method for separating the balance springs is to place them in a small cardboard box and tap the box by hand against a rigid surface. A similar but more industrial method involves using a tapping machine, which generates repeated impacts on the balance springs by means of a cam and springs.

An alternative solution is to chemically generate a layer of a particular compound to drastically reduce sticking between the blades and allow good separation. However, this method limits the possibility of correcting the balance spring's thermal coefficient.

### SUMMARY OF THE INVENTION

The invention proposes to develop another method for separating the balance springs, based on mechanically crushing the balance springs before they pass through the tapping machine.

To this end, the invention relates to a tool for separating a substantially cylindrical or annular balance spring plate after winding in and heat treatment, said tool being arranged to initiate or carry out the separation of said balance springs.

According to the invention, said tool includes a first, lower rolling surface and a second, upper rolling surface that are parallel or substantially parallel to each other and to a base plane, and that are movable relative to each other, on the one hand in a longitudinal direction parallel to said base plane and on the other hand in a vertical direction perpendicular to said base plane, and that are arranged to clamp said plate between a lower generatrix and an upper generatrix under the action of at least one actuator arranged to bring said first lower rolling surface and said second upper rolling surface closer to each other in order to deform said plate by ovalisation, and to subject a substantially cylindrical peripheral surface of said plate to a rolling movement between said first lower rolling surface and said second upper rolling surface under the action of at least one actuator arranged to impart a relative movement in said longitudinal direction between said first lower rolling surface and said second upper rolling surface.

Another aspect of the invention relates to a method for separating balance springs from a plate after winding in and heat treatment.

According to the invention, such a tool is used to mechanically crush said plate in the elastic range, minimum and maximum values of the crushing ratio of a substantially cylindrical peripheral surface of said plate are determined, said plate is subjected to at least one said rolling sequence in a compressed position, minimum and maximum values of rotation per sequence are determined, minimum and maximum values of cumulative rotation are determined for a set of sequences, the number whereof is determined, one said plate is positioned between said first lower rolling surface and said second upper rolling surface of said tool, by the action of an operator or of a robotised manipulator, and for each said sequence, the following steps are carried out: a first step of compressing said plate by a predetermined vertical stroke, a second step of moving said first lower rolling surface and said second upper rolling surface relative to one another through a predetermined longitudinal stroke, and a third step of moving said first lower rolling surface and said second upper rolling surface away from one another into a spaced-apart position in which said plate is not subjected to any compressive stress.

### BRIEF DESCRIPTION OF THE FIGURES

The aims, advantages and features of the invention will become clearer from the detailed description that follows, with reference to the accompanying drawings, in which:

FIG. 1 diagrammatically shows a side view of a balance spring plate including, after winding in and heat treatment, a plurality of balance springs wound one on top of the other and staggered along their length;

FIG. 2 diagrammatically shows a perspective view of the balance spring plate in FIG. 1;

FIG. 3 diagrammatically shows a side view of a tool according to the invention, including an upper rolling surface and a lower rolling surface, both bearing against the edge of the balance spring plate of FIG. 1, along an upper generatrix and a lower generatrix of this plate respectively;

FIG. 4 diagrammatically shows, in a similar manner to FIG. 3, the same tool including a mandrel to limit the radial motion of the plate;

FIG. 5 diagrammatically shows, in a similar manner to FIG. 3, the same tool, wherein the plate is placed edgeways on the lower rolling surface, and wherein the upper rolling surface is detached and at a distance from the plate;

FIG. 6 diagrammatically shows, in a similar manner to FIG. 5, the same tool, and wherein the upper rolling surface close to the lower rolling surface and compressively bearing against the plate, which is ovalised as a result of the compression;

FIG. 7 diagrammatically shows, in a similar manner to FIG. 6, the same tool, and wherein the upper rolling surface and lower rolling surface are moving longitudinally relative to one another, still compressively bearing against the plate, which is ovalised as a result of the compression;

FIG. 8 diagrammatically shows, in a similar manner to FIG. 7, the same tool, and wherein the upper rolling surface is away from the plate, which regains its substantially cylindrical shape;

FIG. 9 diagrammatically shows a perspective view of the same tool, which has two side plates on either side of the plate to limit its transverse play;

FIG. 10 diagrammatically shows, in a similar manner to FIG. 9, the same tool, including a mandrel similar to that of FIG. 4, which mandrel is guided in relation to the side plates.

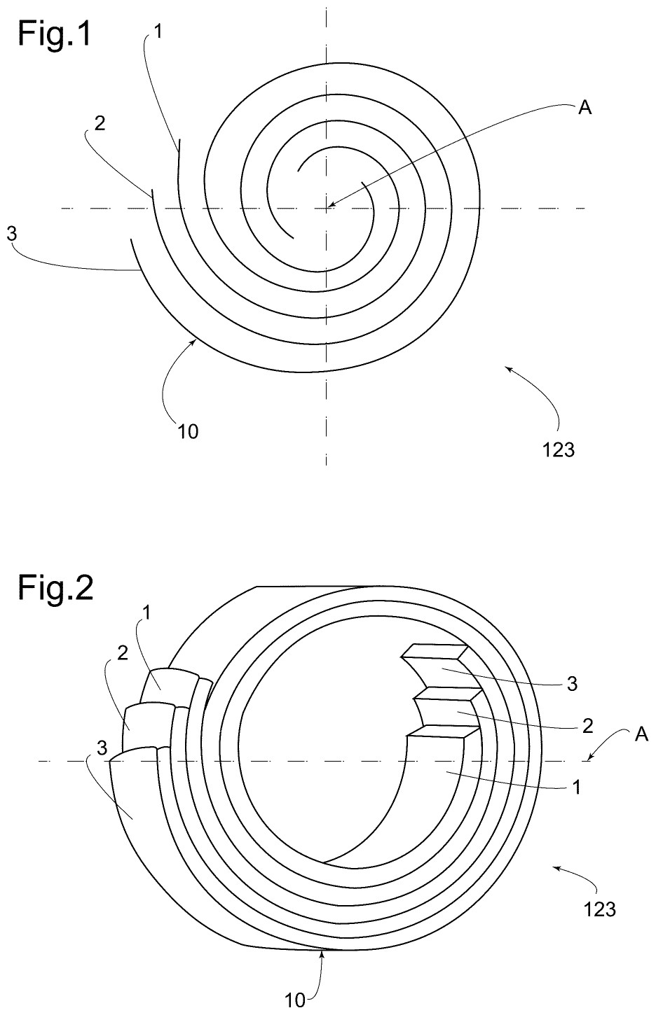

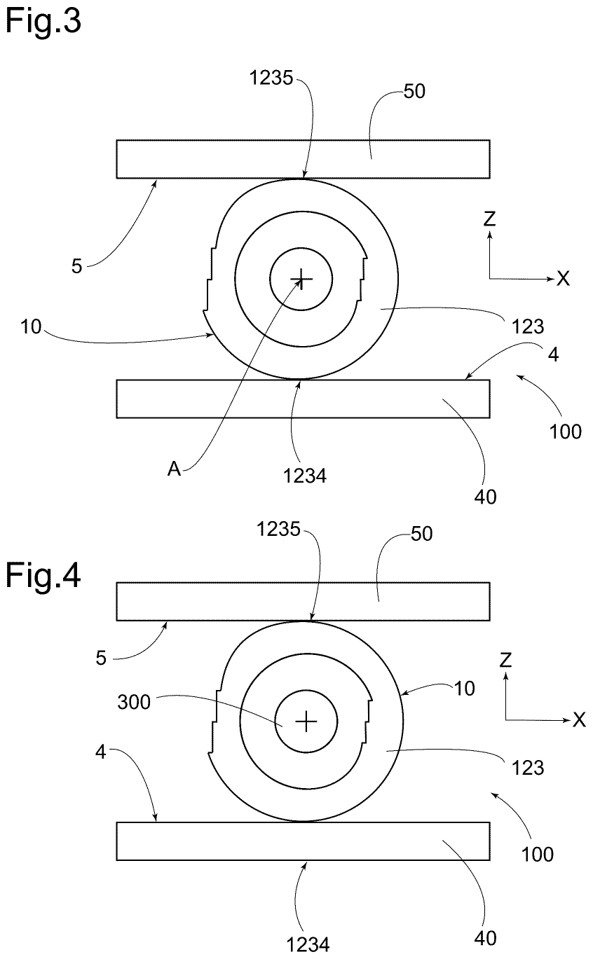

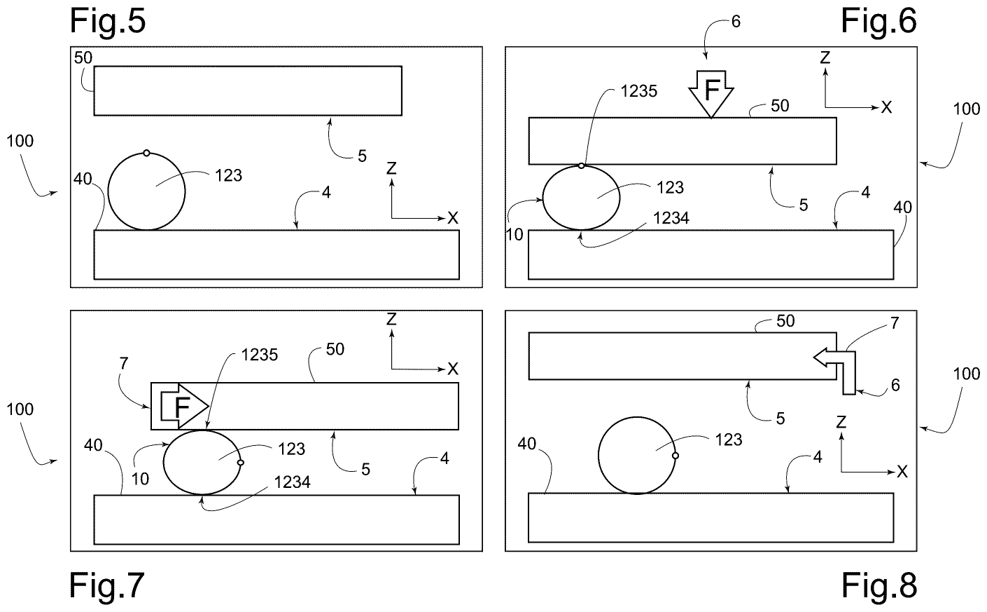

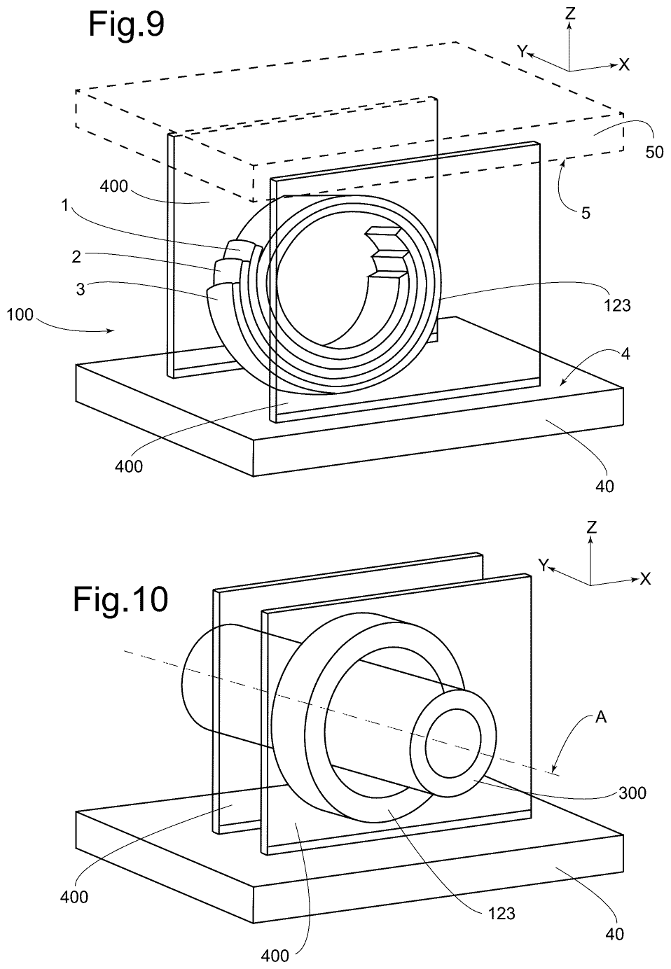

### DETAILED DESCRIPTION OF THE INVENTION

The invention relates to a method for mechanical crushing, in the elastic range, of plates of wound and fixed balance springs, which method makes it possible to significantly improve the rate of separation of the balance springs.

The figures illustrate a particular and by no means limiting application of the invention to a balance spring plate 123, the invention concerning the separation of the springs 1, 2, 3, constituting this balance spring plate 123. This example of three balance springs is purely didactic, and it is understood that the invention is applicable to any common balance spring plate.

Rolling by crushing consists of subjecting the balance spring plates, directly after fixing, to a mechanical stress which will deform them elastically, in order to help the blades of the balance springs to separate from each other and facilitate the separation process. It is thus important to note that this rolling is not strictly speaking a separation method, but it is a preliminary step which, if carried out correctly, can significantly reduce the rate of rejects during separation.

The plate of wound and fixed balance springs is placed vertically in a vertical Z direction, i.e. edgeways, on a horizontal support in a plane XY. A tool 100 includes a mechanical actuator which then crushes the plate by moving it in the vertical direction Z. This action generates a compressive stress at the poles, and a tensile stress at the equator of the balance spring plate 123; it is this tensile stress that is used locally to help detach the blades of the balance springs 1, 2, 3. Once the balance spring plate 123 has been crushed, a mechanical actuator, which can be the same as the one initiating the crushing, induces a lateral displacement in a longitudinal direction X; this will rotate the balance spring plate 123 (hence the term “rolling”), while maintaining the crushing in the vertical direction Z. The result is a tensile stress that successively affects all of the portions of the blades as the balance spring plate 123 rolls. There is also a gradual sliding of the blades relative to one another, which also contributes to the detachment effect. Once the longitudinal displacement is complete, the crushing is ended and the balance spring returns to its initial shape. The tool then initiates a reverse longitudinal displacement in order to return to its initial position. This cycle is repeated a plurality of times, to ensure that each portion of the balance spring plate has undergone a plurality of tensile stress phases.

The crush rolling process is controlled by a number of critical parameters.

The crush ratio is a key parameter, as it will determine the intensity of the tensile stresses that will help the blades to detach. However, it must not be too high, to avoid plastic deformation of the balance spring plate 123. It is preferably chosen within the range of 1.5% to 5.6% of the diameter of the balance spring plate 123.

The length of the longitudinal displacement of the actuator makes it possible to vary the extent of the zone where the tensile stresses are applied. To achieve effective rolling, it is important that all portions of the balance spring plate 123 have been under tensile stress at some point. Typically, each cycle of lateral displacement induces a rotation of between ⅛ revolution and 1 complete revolution of the balance spring plate.

The number of rolling cycles depends both on the longitudinal displacement of the actuator at each cycle and on the length of the base of the rolling device. It has been noted that an optimum exists because too few rolling cycles have a very limited impact on improving the separation rate, whereas too much rolling will induce mechanical locking of the blades which will then become inseparable. The number of revolutions varies between ½ and 100, preferably between 1 and 10, even more preferably between 2 and 4.

The balance spring plates are inserted in such a way that they roll in the opposite direction to the Archimedean spiral, otherwise the ends of the blades at the periphery of the balance spring plate 123 can catch on the base and plastically deform the balance spring.

In the transverse direction Y, i.e. perpendicular to the rolling plane, it is advantageous to place a plate, in particular a plexiglass pane, whose role is to limit the displacement of the plates in this transverse direction Y, while giving the necessary space for rolling with minimum friction. It also allows the blades to be pinned together at regular intervals.

Once the balance spring plates 123 have passed through the tool 100 according to the invention constituting the rolling device, the standard separation processes (cardboard box or tapping machine) can be successfully applied.

More particularly, the invention is based on the use of a tool 100 for separating a substantially cylindrical or annular plate 123 of balance springs 1, 2, 3, after winding in and heat treatment. This tool 100 is intended to initiate or carry out the separation of the balance springs 1, 2, 3.

According to the invention, the tool 100 includes a first lower rolling surface 4 and a second upper rolling surface 5 parallel or substantially parallel to each other and to a base plane XY, and movable relative to each other, on the one hand in a longitudinal direction X parallel to the base plane XY, and on the other hand in a vertical direction Z perpendicular to the base plane XY.

This first lower rolling surface 4 and this second upper rolling surface 5 are arranged to clamp the plate 123 between a lower generatrix 1234 and an upper generatrix 1235 under the action of at least one actuator 6, 7, arranged to bring the first lower rolling surface 4 and the second upper rolling surface 5 closer together to deform the plate 123 by ovalisation.

This first lower rolling surface 4 and this second upper rolling surface 5 are also arranged to subject a substantially cylindrical peripheral surface 10 of the plate 123 to a rolling movement between the first lower rolling surface 4 and the second upper rolling surface 5, under the action of at least one actuator 6, 7, arranged to impart a relative movement in the longitudinal direction X between the first lower rolling surface 4 and the second upper rolling surface 5.

More particularly, the tool 100 includes control means 200 which are arranged to initiate a vertical stroke, in the vertical direction Z, of the first lower rolling surface 4 relative to the second upper rolling surface 5 and to initiate a longitudinal stroke, in the longitudinal direction X, of the first lower rolling surface 4 relative to the second upper rolling surface 5.

More particularly, these control means 200 are arranged to initiate at least one sequence including, after the plate 123 has been positioned between the first lower rolling surface 4 and the second upper rolling surface 5 by an operator or a robotised manipulator, a first step of compressing the plate 123 by a predetermined vertical stroke of the first actuator 6, a second step of moving the first lower rolling surface 4 and the second upper rolling surface 5 relative to one another through a predetermined longitudinal stroke, and a third step of moving the first lower rolling surface 4 and the second upper rolling surface 5 away from one another into a spaced-apart position in which the plate 123 is not subjected to any compressive stress.

More particularly, the predetermined vertical stroke is between 1.5% and 5.6% of the maximum diameter of the substantially cylindrical peripheral surface 10 of the plate 123.

More particularly, the predetermined longitudinal stroke is intended to impart a rotation of between ⅛ revolution and 1 revolution to the plate 123.

More particularly, the control means 200 are arranged to initiate, in at least one sequence, a fourth step of moving the first lower rolling surface 4 and the second upper rolling surface 5 relative to each other to return them to the position they occupy relative to each other in the first step.

More particularly, the control means 200 are arranged to initiate a plurality of such sequences with a cumulative rotation of the plate 123 of between 0.5 revolutions and 100 revolutions.

More particularly, the control means 200 are arranged to initiate a plurality of such sequences with a cumulative rotation of the plate 123 of between 1 revolution and 10 revolutions.

More particularly, the control means 200 are arranged to initiate a plurality of such sequences with a cumulative rotation of the plate 123 of between 2 and 4 revolutions.

More particularly, the tool 100 includes, transversely in a transverse direction Y perpendicular to the longitudinal direction X and to the vertical direction Z, at least one plate 400 including a flat surface for limiting the transverse stroke of the plate 123. More particularly, the tool 100 includes, transversely and on either side of the plate 123, two such plates for limiting the transverse stroke of the plate 123, at least one of which is transparent.

More particularly, the tool 100 includes a mandrel 300 insertable in a said plate 123 and arranged to limit its stroke when being handled in the tool 100. More particularly, the mandrel 300 is dimensioned, relative to a plate 123 of given geometry, with a radial clearance which is greater than the predetermined vertical stroke, which is a maximum compression stroke initiated by the control means 200. More particularly, this mandrel 300 is guided by recesses or trunnions included in two such parallel plates 400.

More particularly, the first lower rolling surface 4 is a surface of a rigid lower plate 40 and/or the second upper rolling surface 5 is a surface of a rigid upper plate 50.

In a first alternative embodiment, the first lower rolling surface 4 and/or the second upper rolling surface 5 is a flat surface.

In a second alternative embodiment, the first lower rolling surface 4 and/or the second upper rolling surface 5 includes a corrugation. More particularly, this corrugation is aperiodic.

In a second alternative embodiment, the first lower rolling surface 4 and the second upper rolling surface 5 can be oriented relative to each other in a position in which planes internally tangential thereto, on the plate 123 side, are inclined relative to each other at a predetermined angle of less than 5°.

More particularly, the tool 100 includes a first actuator 6, which is arranged to bring the first lower rolling surface 4 and the second upper rolling surface 5 closer together in the vertical direction Z in order to deform the plate 123 by ovalisation.

More particularly, the tool 100 includes a second actuator 7, which is arranged to subject a substantially cylindrical peripheral surface 10 of the plate 123 to a rolling movement on the first lower rolling surface 4 and the second upper rolling surface 5. More particularly, the second actuator 7 is arranged to initiate a relative movement in the longitudinal direction X between the first lower rolling surface 4 and the second upper rolling surface 5.

More particularly, the second actuator 7 is merged with the first actuator 6, which is the only actuator included in the tool 100, and which includes switching means for separately initiating a relative movement between the first lower rolling surface 4 and the second upper rolling surface 5, in the vertical direction Z or in the longitudinal direction X.

In particular, the control means 200 are automated.

In particular, the control means 200 are manual.

The invention further relates to a method for separating balance springs 1, 2, 3 from a plate 123 after winding in and heat treatment.

According to the invention, such a tool 100 is used to mechanically crush the plate 123 in the elastic range, minimum and maximum crush rate values are determined for a substantially cylindrical peripheral surface 10 of the plate 123, the plate 123 is subjected to at least one rolling sequence in a compressed position, minimum and maximum rotation values are determined per sequence, minimum and maximum cumulative rotation values are determined for a set of sequences, the number of which is determined, a plate 123 is positioned between the first lower rolling surface 4 and the second upper rolling surface 5 of the tool 100, by the action of an operator or a robotised manipulator, and for each sequence, the following steps are successively carried out: a first step of compressing the plate 123 by a predetermined vertical stroke, a second step of moving the first lower rolling surface 4 and the second upper rolling surface 5 relative to one another through a predetermined longitudinal stroke, a third step of moving the first lower rolling surface 4 and the second upper rolling surface 5 away from one another into a spaced-apart position in which the plate 123 is not subjected to any compressive stress.

More particularly, during the sequences, the blades of the springs 1, 2, 3 are crushed radially at regular intervals. In another alternative embodiment, the blades of the springs 1, 2, 3 are crushed radially at irregular intervals between the first, lower rolling surface 4 and the second, upper rolling surface 5.

More particularly, after having carried out a plurality of crushing operations by rolling in accordance with this method, the springs 1, 2, 3 are mechanically separated by placing the plate 123 in a cardboard box which is subjected to impacts on a rigid surface, and/or by subjecting the plate 123 to a tapping machine which generates repeated impacts on the balance springs 1, 2, 3 of the plate 123.

In short, separation is assisted by crushing the material through rolling in the elastic range, and this method leaves no trace on the balance spring.

This process of separating the balance springs, based on crushing by rolling, on a suitable tool, makes it possible to significantly increase the rate of separated balance springs, for balance springs made of titanium alloy, and to increase very significantly the proportion of balance springs that are fit for service.

1. A tool for separating a substantially cylindrical or annular plate of balance springs after winding in and heat treatment, said tool being arranged to initiate or carry out the a separation of said balance springs, characterised in that wherein said tool includes a first lower rolling surface (4) and a second upper rolling surface parallel or substantially parallel to each other and to a base plane (XY), and movable relative to each other, in a longitudinal direction (X) parallel to said base plane (XY), and in a vertical direction (Z) perpendicular to said base plane (XY), and arranged to clamp said plate between a lower generatrix and an upper generatrix under the action of at least one actuator arranged to bring said first lower rolling surface and said second upper rolling surface closer together to deform said plate by ovalisation, and to subject a substantially cylindrical peripheral surface of said plate to a rolling movement between said first lower rolling surface and said second upper rolling surface under the action of at least one actuator arranged to impart a relative movement in said longitudinal direction (X) between said first lower rolling surface and said second upper rolling surface.

2. The tool according to claim 1, characterised in wherein said tool includes control means arranged to initiate a vertical stroke, in said vertical direction (Z), of said first lower rolling surface relative to said second upper rolling surface and to initiate a longitudinal stroke, in said longitudinal direction (X), of said first lower rolling surface relative to said second upper rolling surface.

3. The tool according to claim 2, wherein said control means are arranged to initiate at least one sequence including, after said plate has been positioned between said first lower rolling surface and said second upper rolling surface by an operator or a robotised manipulator, a first step of compressing said plate by a predetermined vertical stroke of said first actuator, a second step of moving said first lower rolling surface and said second upper rolling surface relative to one another through a predetermined longitudinal stroke, a third step of moving said first lower rolling surface and said second upper rolling surface away from one another into a spaced-apart position in which said plate is not subjected to any compressive stress.

4. The tool according to claim 3, wherein said predetermined vertical stroke is between 1.5% and 5.6% of the maximum diameter of said substantially cylindrical peripheral surface of said plate.

5. The tool according to claim 3, wherein said predetermined longitudinal stroke is arranged to impart to said plate a rotation of between ⅛ revolution and 1 revolution.

6. The tool according to claim 3, wherein said control means are arranged to initiate, in said at least one sequence, a fourth step of moving said first lower rolling surface and said second upper rolling surface relative to each other to return them to the position they occupy relative to each other in said first step.

7. The tool according to claim 3, wherein said control means are arranged to initiate a plurality of said sequences with a cumulative rotation of said plate of between 0.5 revolutions and 100 revolutions.

8. The tool according to claim 7, wherein said control means are arranged to initiate a plurality of said sequences with a cumulative rotation of said plate of between 1 revolution and 10 revolutions.

9. The tool according to claim 8, wherein said control means are arranged to initiate a plurality of said sequences with a cumulative rotation of said plate of between 2 and 4 revolutions.

10. The tool according to claim 1, wherein said tool includes, transversely in a transverse direction Y perpendicular to said longitudinal direction X and to said vertical direction Z, at least one plate including a flat surface for limiting the transverse stroke of said plate.

11. The tool according to claim 10, wherein said tool includes, transversely and on either side of said plate, two said plates for limiting the transverse stroke of said plate, at least one of which is transparent.

12. The tool according to claim 1, wherein said tool includes a mandrel insertable into a said plate and arranged to limit its stroke when being handled in said tool.

13. The tool according to claim 3, wherein said mandrel is dimensioned, relative to a said plate, with a radial clearance which is greater than said predetermined vertical stroke, which is a maximum compression stroke initiated by said control means.

14. The tool according to claim 1, wherein said first lower rolling surface is a surface of a rigid lower plate and/or said second upper rolling surface is a surface of a rigid upper plate.

15. The tool according to claim 1, wherein said first lower rolling surface or/and said second upper rolling surface is a flat surface.

16. The tool according to claim 1, wherein said first lower rolling surface and/or said second upper rolling surface includes a corrugation.

17. The tool according to claim 16, wherein said corrugation is aperiodic.

18. The tool according to claim 1, wherein said first lower rolling surface and said second upper rolling surface are orientable relative to each other in a position in which planes tangential thereto, on said plate side, are inclined relative to each other at a predetermined angle of less than 5°.

19. The tool according to claim 1, wherein said tool includes a first actuator arranged to bring said first lower rolling surface and said second upper rolling surface closer together in said vertical direction (Z) in order to deform said plate by ovalisation.

20. The tool according to claim 1, wherein said tool includes a second actuator arranged to subject a substantially cylindrical peripheral surface of said plate to a rolling movement on said first lower rolling surface and said second upper rolling surface.

21. The tool according to claim 20, wherein said second actuator is arranged to initiate a relative movement in said longitudinal direction (X) between said first lower rolling surface and said second upper rolling surface.

22. The tool according to claim 19, wherein said second actuator is merged with said first actuator which is the only actuator that said tool includes, and which includes switching means for separately initiating a relative movement between said first lower rolling surface and said second upper rolling surface, according to said vertical direction (Z) or according to said longitudinal direction (X).

23. The tool according to claim 2, wherein said control means are automated.

24. The tool according to claim 2, wherein said control means are manual.

25. A method for separating balance springs from a plate after winding in and heat treatment, the method comprising:
providing a tool in accordance with claim 1 for mechanically crushing said plate in the elastic range,
determining that minimum and maximum crush rate values for a substantially cylindrical peripheral surface of said plate,
subjecting said plate to at least one said rolling sequence in a compressed position,
determining minimum and maximum rotation values per sequence,
determining minimum and maximum cumulative rotation values for a set of sequences, the number of which is determined,
positioning a said plate between said first lower rolling surface and said second upper rolling surface of said tool by action of an operator or a robotised manipulator, and
carrying out, for each said sequence, the following steps successively: a first step of compressing said plate by a predetermined vertical stroke, a second step of moving said first lower rolling surface and said second upper rolling surface relative to one another through a predetermined longitudinal stroke, a third step of moving said first lower rolling surface and said second upper rolling surface away from one another into a spaced-apart position in which said plate is not subjected to any compressive stress.

26. The method according to claim 25, wherein, during said sequences, the blades of said springs are radially crushed at regular intervals between said first lower rolling surface and said second upper rolling surface.

27. The method according to claim 25, wherein, after having carried out a plurality of crushing operations by rolling according to said method, said springs are mechanically separated by placing said plate in a cardboard box which is subjected to impacts on a rigid surface, and/or by subjecting said plate to a tapping machine generating repeated impacts on said balance springs of said plate.
